(19) United States
(12) Patent Application Publication
(10) Pub. No.: US 2022/0288847 A1
(43) Pub. Date: Sep. 15, 2022

(54) NOZZLE ASSEMBLY FOR PRINTER HEAD OF 3D PRINTER

(71) Applicant: ESSENTIUM, INC., Pflugerville, TX (US)

(72) Inventors: William Jack MacNeish, III, Santa Ana, CA (US); Ryan Vano, Pflugerville, TX (US)

(21) Appl. No.: 17/736,626

(22) Filed: May 4, 2022

Related U.S. Application Data
(63) Continuation of application No. PCT/US2020/059154, filed on Nov. 5, 2020.
(60) Provisional application No. 62/930,662, filed on Nov. 5, 2019.

(51) Int. Cl. B29C 64/209; B29C 64/295; B29C 64/393; B33Y 50/02; B33Y 30/00

(52) U.S. Cl. CPC B29C 64/209; B29C 64/295; B29C 64/393; B33Y 50/02; B33Y 30/00; B29C 64/118

(57) ABSTRACT

A nozzle assembly for a printer head of a 3D printer includes a guide held in a fixed position relative to the printer head and extending from a first end to a second end along a longitudinal axis. A drive mechanism extends from a feed end to a discharge end along the longitudinal axis. The feed end defines a feed opening for receiving a filament from a feed system, and the discharge end defines a discharge opening for discharging the filament from the nozzle assembly. The drive mechanism is movable relative to the guide, and the drive mechanism includes a drive surface for engaging the filament and causing the filament to move from the feed opening to the discharge opening, in response to the drive mechanism moving relative to the printer head. The nozzle assembly further includes a motor for moving the drive mechanism relative to the printer head.

### CROSS-REFERENCE TO RELATED APPLICATIONS

This application is a continuation of international application number PCT/US2020/059154, filed on Nov. 5, 2020, which claims priority to U.S. provisional patent application No. 62/930,662 filed on Nov. 5, 2019. The contents of these applications are incorporated herein by reference in their entirety.

### TECHNICAL FIELD

The present disclosure relates generally to three-dimensional printers and more particularly to a nozzle assembly for a printer head of a three-dimensional printer configured for fused filament fabrication (FFF).

### BACKGROUND ART

The statements in this section merely provide background information related to the present disclosure and may or may not constitute prior art.

Three-dimensional printers form three dimensional objects from computer generated models. In some instances, the printers deposit a feed stock in an additive manufacturing process. The feed stock may be deposited utilizing a printer head, which draws the feedstock, such as a thermoplastic filament, from a spool contained within a cannister. The printer head may move in a three-dimensional path while heating and depositing the feedstock to form the object. For example, the printer head may deposit the feedstock in a first layer and then, either the printer head, or the support table, may be moved to form successive layers. This process may then be repeated until the object is completed.

A number of challenges arise in the printing of objects using conventional spools for three-dimensional printers. One challenge in the printing process is that the 3D printer can include multiple movable components, which can increase inertial forces on the printer head. These inertial forces can reduce the responsivity and life cycle of the printer head and other components of the 3D printer.

Thus, while current nozzle assemblies for printer heads of 3D printers achieve their intended purpose, there is a need for a new and improved nozzle assembly for a printer head that addresses these issues.

### SUMMARY

According to several aspects of the disclosure, a nozzle assembly for a printer head of a 3D printer includes a guide held in a fixed position relative to the printer head. The guide extends from a first end to a second end along a longitudinal axis. The nozzle assembly further includes a drive mechanism extending from a feed end to a discharge end along the longitudinal axis. The feed end defines a feed opening for receiving a filament, and the discharge end defines a discharge opening for discharging the filament from the nozzle assembly. The drive mechanism is movable relative to the printer head and the guide. The drive mechanism includes at least one drive surface for engaging the filament and causing the filament to move from the feed opening to the discharge opening, in response to the drive mechanism moving relative to the printer head. The nozzle assembly further includes a motor for moving the drive mechanism relative to the printer head.

According to several aspects of the disclosure, a nozzle assembly for a printer head of a 3D printer includes a guide held in a fixed position relative to the printer head. The guide extends from a first end to a second end along a longitudinal axis, and the guide comprises an auger that defines a cavity. The nozzle assembly further includes a heating element, which is disposed within the cavity of the auger and held in a fixed position relative to the printer head. The nozzle assembly further includes a drive mechanism extending from a feed end to a discharge end along the longitudinal axis. The feed end defines a feed opening for receiving a filament from the feed system, and the discharge end defines a discharge opening for discharging the filament from the nozzle assembly. The drive mechanism is movable relative to the printer head and the guide. The drive mechanism includes at least one drive surface for engaging the filament and causing the filament to move from the feed opening to the discharge opening, in response to the drive mechanism moving relative to the printer head. The nozzle assembly further includes a motor for moving the drive mechanism relative to the printer head.

According to several aspects of the disclosure, a printer head for a 3D printer includes a nozzle assembly. The nozzle assembly includes a guide held in a fixed position relative to the printer head. The guide extends from a first end to a second end along a longitudinal axis. The guide comprises an auger that defines a cavity. The nozzle assembly further includes a heating element comprising a resistive wire, which is disposed within the cavity of the auger and held in a fixed position relative to the printer head. The nozzle assembly further includes a sensor attached to the guide, such that the sensor is held in a fixed position relative to the printer head. The sensor is configured to measure heat based on a resistance change in the resistive wire. The nozzle assembly further includes a drive mechanism extending from a feed end to a discharge end along the longitudinal axis. The feed end defines a feed opening for receiving a filament from the feed system, and the discharge end defines a discharge opening for discharging the filament from the nozzle assembly. The drive mechanism is movable relative to the printer head and the guide. The drive mechanism includes at least one drive surface for engaging the filament and causing the filament to move from the feed opening to the discharge opening, in response to the drive mechanism moving relative to the printer head. The nozzle assembly further includes a motor for moving the drive mechanism relative to the printer head. The printer head further includes a feed system for feeding the filament into the nozzle assembly.

### DRAWINGS

The drawings described herein are for illustration purposes only and are not intended to limit the scope of the present disclosure in any way.

FIG. 1 a perspective view of an example of a printer head for a three-dimensional printer (“3D printer”) and for use with a support table, illustrating the printer head having a nozzle assembly;

FIG. 2 is an enlarged perspective view of the nozzle assembly of FIG. 1 illustrated in further detail, in accordance with an aspect of the present invention;

FIG. 3 is a top view of the nozzle assembly of FIG. 2;

FIG. 4 is a side view of the nozzle assembly of FIG. 2;

FIG. 5 is a bottom view of the nozzle assembly of FIG. 2; and

FIG. 6 is a cross-sectional view of the nozzle assembly of FIG. 2 as taken along line 6-6, in accordance with an aspect of the present invention.

### DETAILED DESCRIPTION

The following description is merely exemplary in nature and is not intended to limit the present disclosure, application, or uses.

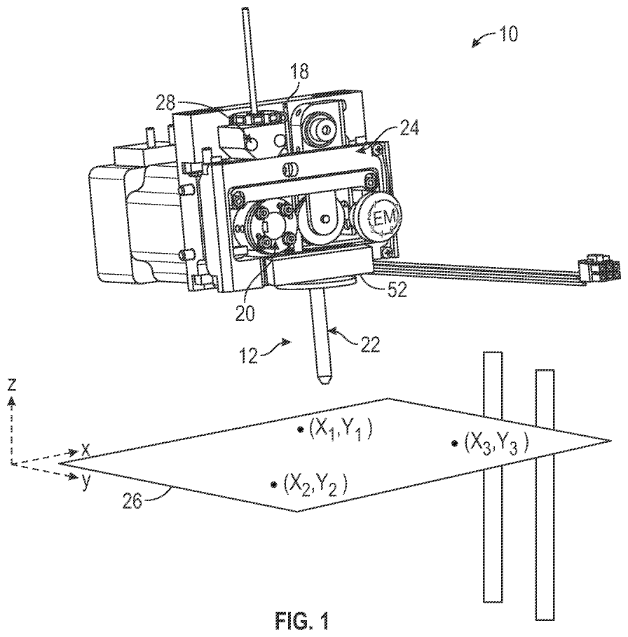

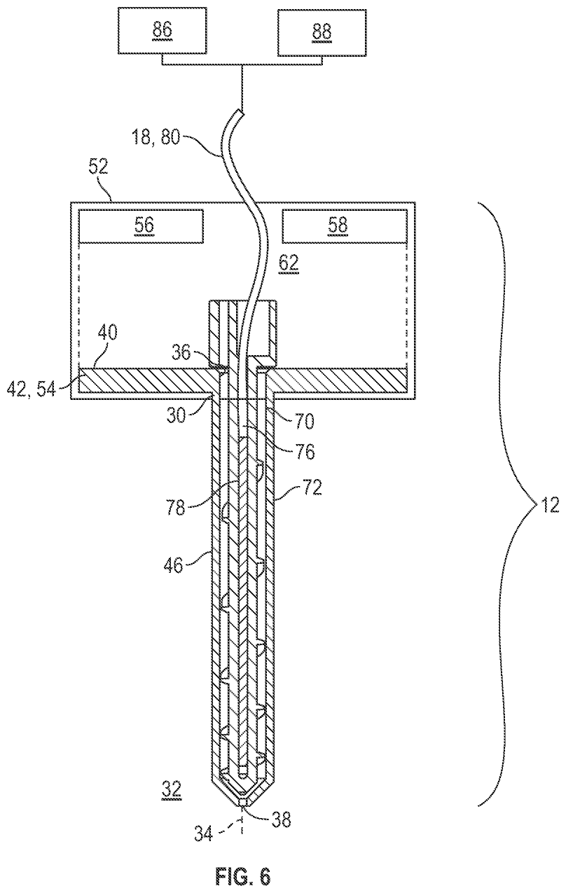

Referring to FIG. 1, a printer head 10 for a three-dimensional printer (3D printer) has a nozzle assembly 12, which includes a heating element 14 (FIG. 6) and one or more sensors 16 (FIG. 6) that are held in fixed positions relative to the printer head 10 for extruding melted materials at volumetric rates and under pressures greater than those associated with a conventional hob feeder and nozzle system. In addition, the printer head 10 and nozzle assembly 12 have a responsivity for changing volumetric rate and pressure within a millisecond. However, it is contemplated that the printer head and nozzle assembly can be configured to extrude melted materials at any volumetric rate, under any pressure, and with a responsivity above or below one millisecond.

The nozzle assembly 12 is configured to receive, heat, and dispense a 3D filament 18 to progressively build a 3D structure. The 3D filament 18 typically is an elongated tubular member made of various polymer or non-polymer materials. Non-limiting examples of filament materials include polyester, polyether ether ketone, polyethylene, and thermoplastic elastomers. In addition, the materials may include various modifiers that may alter the mechanical, chemical or visco-elastic properties of the material. The nozzle assembly 12 receives the 3D filament 18 from one or more spools (not shown), heats the 3D filament to a predetermined temperature, and dispenses the 3D filament onto a support table 26. The 3D structure is formed by dispensing successive layers of the 3D filament material from the nozzle. A variety of different 3D filament materials may be used to build different 3D structures having different structural properties and appearances.

In this example, the printer head 10 further includes a feed system 20 for drawing filament 18 from a spool (not shown) and feeding the filament 18 into the nozzle assembly 12. However, in other examples, the printer head 10 may not include the feed system because the nozzle assembly 12 includes a separate drive mechanism 22 for feeding filament through the nozzle assembly 12 as will be described in detail below.

The printer head 10 includes a z-axis plate assembly 24 for carrying the nozzle assembly 12 along the z-axis, in upward and downward directions relative to the support table 26, which supports the 3D printed article independently of the feed system 20. Furthermore, a sensor assembly 28 is provided, which detects the location of the nozzle assembly 12 relative to the support table 26. It is contemplated that the nozzle assembly can include sensors for detecting any suitable parameter or condition of the nozzle assembly or filament therein.

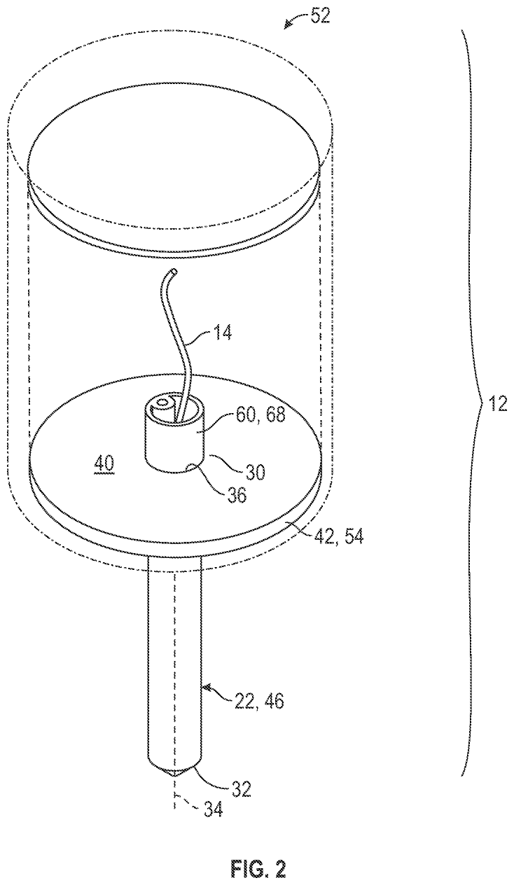

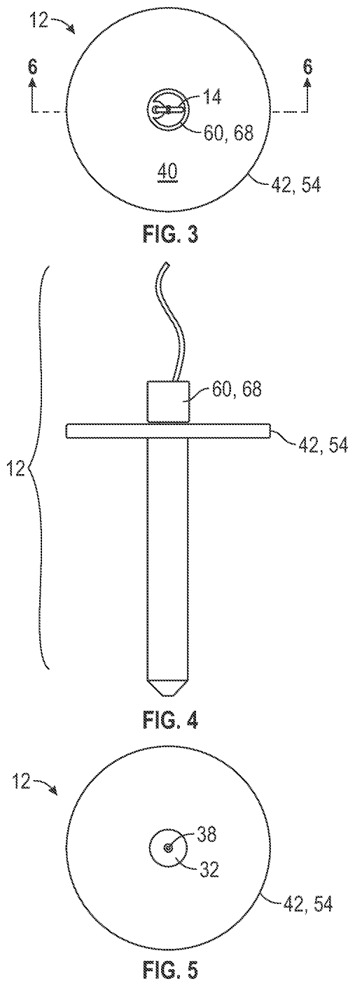

FIGS. 2-6 are enlarged views of the nozzle assembly 12 of FIG. 1. As best shown in FIG. 6, the nozzle assembly 12 includes a drive mechanism 22 that extends from a feed end 30 to a discharge end 32 along a longitudinal axis 34. The feed end 30 defines a feed opening 36 for receiving the filament 18 from the feed system 20, and the discharge end 32 defines a discharge opening 38 for discharging the filament 18 from the nozzle assembly 12. The drive mechanism 22 is movable relative to the printer head 10 (FIG. 1) to cause the filament 18 to move from the feed end 30 to the discharge end 32.

Referring again to FIG. 6, the drive mechanism 22 includes one or more driven surfaces 40 configured to receive an input force for moving the drive mechanism 22 relative to the printer head 10 (FIG. 1). In this example, the drive mechanism 22 includes an annular flange 42 including the driven surface 40 for receiving an input force as described in detail below. Furthermore, the drive mechanism 22 includes one or more drive surfaces 44 for engaging the filament 18 and causing it to move from the from the feed opening 36 to the discharge opening 38, in response to the drive mechanism 22 moving relative to the printer head 10.

More specifically, in this example, the drive mechanism 22 is a nozzle 46 rotatably mounted to the printer head 10 (FIG. 1) by, for example, a free bearing that permits the nozzle 46 to be quickly released and attached to the printer head 10. Also, in this example, the nozzle 46 is a tubular sleeve, and the drive surface 44 is an inner diameter surface 48 of the sleeve 46 that defines an elongated bore 50 in fluid communication between the feed opening 36 and the discharge opening 38. Rotation of the sleeve 46 relative to the printer head 10 causes the inner diameter surface 48 to transmit a rotational force to the filament 18 disposed within the bore 50. It is contemplated that the drive mechanism may be any suitable nozzle with a constant inner diameter surface or a stepped inner diameter surface that defines a bore, with the surface transmitting force to filament within the bore. In addition, the drive mechanism can be displaceable in any rotational motion or any oscillatory motion along any linear, arcuate, or other suitably shaped path relative to the printer head 10 for causing the filament 18 to move from the feed opening 36 to the discharge opening 38.

The nozzle assembly 12 further includes a motor 52 for moving the drive mechanism 22 relative to the printer head 10. Continuing with the previous example, the annular flange 42 of the sleeve 46 provides a rotor 54 disposed integrally within the motor 52 for providing precise direct drive of the sleeve 46 relative to the printer head 10 and the associated precise control of the volumetric rate and pressure for discharging filament from the nozzle assembly. It is contemplated that the nozzle assembly can include a belt drive, gear arrangement, or the like for moving the drive mechanism relative to the printer head and discharging filament from the nozzle assembly.

The nozzle assembly 12 further includes a guide 60 that cooperates with the drive mechanism 22 to displace the filament 18 from the feed opening 36 to the discharge opening 38. The guide 60 extends from a first end 62 to a second end 64 along the longitudinal axis 34, and the guide 60 is held in a fixed position relative to the printer head 10 (FIG. 1), such that the drive mechanism 22 is movable relative to both of the printer head 10 and the guide 60. The guide 60 is disposed at least partially within the bore 50 of the drive mechanism 22, and the guide 60 includes one or more guide surfaces 66 configured to deflect the filament 18 toward the discharge end 32, in response to the drive mechanism 22 moving relative to the guide 60.

In continuation with the previous non-limiting example, the guide 60 is an auger 68 including an elongated shaft 70 disposed at least partially within the bore 50 of the sleeve 46. The auger 68 further includes a helical ramp 72 or thread extending from the elongated shaft 70. The ramp 72 has a bottom surface 74 that defines the guide surface 66, and the helical ramp 72 has a left or right handedness such that the guide surface 66 deflects the filament 18 toward the discharge end 32, in response to the sleeve 46 rotating about the longitudinal axis 34 for transmitting a rotational force to the filament in a rotational direction associated with the handedness of the helical ramp 72. However, it is contemplated that the guide can be other suitable mechanisms for cooperating with the drive mechanism to displace the filament from the feed opening 36 to the discharge opening 38.

The heating element 14, the sensors 16, other suitable components, or any combination thereof may be attached to the guide 60, such that the heating element 14, sensors 16, and other components are held in fixed positions relative to the printer head 10. It is contemplated that reducing or eliminating movement of the heating element 14, the sensors 16, or other components can reduce inertial forces on the nozzle assembly and increase its responsivity and life cycle.

The heating element 14 is attached to the guide 60 and held in a fixed position relative to the printer head 10. In this example, the auger 68 defines a cavity 76, and the heating element 14 a cartridge heater 78 disposed within the cavity 76 with a resistive wire 80 at least partially contained within the cartridge 78. In response to the heating element 14 receiving an electric current, the heating element 14 may be resistively and thermally excited, thereby causing the heating element 14 to heat the cartridge 78, the auger 68, and adjacent portions of the filament 18 through convection, conduction, and/or radiative heat transfer. It is contemplated that the heating element can be other suitable heating elements attached to any portion of the guide 60.

In other embodiments, the length of the guide 60 may be varied, as may be the length of the drive mechanism 22. Variations in auger length may accommodate elements in addition to the heating element 14 and the sensor 16, and the variation may also allow for the most efficient heating of particular print materials. By way of non-limiting example, a drive mechanism may define a bore longer than nozzle bores in the known art, and the bore may include a particular taper at the discharge end 32, so as to enhance the heating properties of the heating element 14. For example, the drive mechanism may define a bore with a taper configured to provide a temperature gradient and correspondingly enhance the maximum feed rate of the filament in the nozzle assembly 12.

The nozzle assembly 12 further includes the sensor 16 attached to the guide 60, such that the sensor 16 is held in a fixed position relative to the printer head 10. The sensor 16 is configured to measure heat based on resistance (or other electrical characteristic) change in the resistive wire 80. The characteristics of the resistive wire 80, such as the resistance or conductance thereof, may be readily sensed in order to assess the heat being delivered to the guide 60 and the filament 18 adjacent thereto. More particularly, the auger 68 and/or the sleeve 46 may be provided with sensors 16 that are embedded in or otherwise associated with auger 68. The data related to changes in, for example, the resistance or conductance of auger 68 may then be directly or indirectly indicative of the temperature of the heating element 14 at the measured point or points, thereby allowing for very precise temperature sensing and control at the discharge end 32. In this example, the sensor 16 is a thermocouple 82 including one or more wires 84 connected to a controller 86 or a power supply 88. However, it is contemplated that the nozzle assembly can include other suitable sensors.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A nozzle assembly for a printer head of a 3D printer, the nozzle assembly comprising:
a guide (60) held in a fixed position relative to the printer head and extending from a first end (62) to a second end (64) along a longitudinal axis (34);
a drive mechanism (22) extending from a feed end (30) to a discharge end (32) along the longitudinal axis (34), the feed end (30) defining a feed opening (36) for receiving a filament (18), the discharge end (32) defining a discharge opening (38) for discharging the filament (18) from the nozzle assembly, and the drive mechanism (22) is movable relative to the printer head and the guide (60) and includes at least one drive surface (44) for engaging the filament (18) and causing the filament (18) to move from the feed opening (36) to the discharge opening (38), in response to the drive mechanism (22) moving relative to the printer head; and
a motor (52) for moving the drive mechanism (22) relative to the printer head.

2. The nozzle assembly of claim 1 wherein the drive mechanism (22) is a nozzle (46) rotatably mounted to the printer head by a free bearing that permits the nozzle (46) to be quickly released and attached to the printer head.

3. The nozzle assembly of claim 2 wherein the nozzle (46) is a tubular sleeve (46), and the at least one drive surface (44) is an inner diameter surface (48) of the sleeve (46) that defines an elongated bore (50) in fluid communication between the feed opening (36) and the discharge opening (38), such that rotation of the sleeve (46) relative to the printer head causes the inner diameter surface (48) to transmit a rotational force to the filament (18) disposed within the bore (50).

4. The nozzle assembly of claim 3 wherein the drive mechanism (22) includes an annular flange (42) extending from the sleeve (46), where the annular flange (42) is a rotor (54) having at least one driven surface (40) configured to receive an input force from the motor (52) for moving the drive mechanism (22) relative to the printer head.

5. The nozzle assembly of claim 4 wherein the guide (60) that cooperates with the drive mechanism (22) to displace the filament (18) from the feed opening (36) to the discharge opening (38), with the guide (60) disposed at least partially within the bore (50) of the drive mechanism (22) and including at least one guide surface (66) configured to deflect the filament (18) toward the discharge end (32) in response to the drive mechanism (22) moving relative to the guide (60).

6. The nozzle assembly of claim 5 wherein the guide (60) is an auger (68) including an elongated shaft (70) disposed at least partially within the bore (50) of the sleeve (46).

7. The nozzle assembly of claim 6 wherein the auger (68) includes a helical ramp (72) extending from the elongated shaft (70), with the helical ramp (72) having a bottom surface (74) defining the at least one guide surface (66).

8. The nozzle assembly of claim 7 wherein the helical ramp (72) has one of a left handedness and a right handedness and is configured to deflect the filament (18) toward the discharge end (32), in response to the sleeve (46) rotating about the longitudinal axis (34) for transmitting a rotational force to the filament (18) in a rotational direction associated with the handedness of the helical ramp (72).

9. A nozzle assembly for a printer head of a 3D printer, the nozzle assembly comprising:
a guide (60) held in a fixed position relative to the printer head and extending from a first end (62) to a second end (64) along a longitudinal axis (34), the guide (60) comprising an auger (68) that defines a cavity (76);
a heating element (14) disposed within the cavity (76) of the auger (68) and held in a fixed position relative to the printer head;
a drive mechanism (22) extending from a feed end (30) to a discharge end (32) along the longitudinal axis (34), the feed end (30) defining a feed opening (36) for receiving a filament (18) from the feed system (20), the discharge end (32) defining a discharge opening (38) for discharging the filament (18) from the nozzle assembly, and the drive mechanism (22) is movable relative to the printer head and the guide (60) and includes at least one drive surface (44) for engaging the filament (18) and causing the filament (18) to move from the feed opening (36) to the discharge opening (38), in response to the drive mechanism (22) moving relative to the printer head; and
a motor (52) for moving the drive mechanism (22) relative to the printer head.

10. The nozzle assembly of claim 9 wherein the heating element (14) is a cartridge heater (78) disposed within the cavity (76) with a resistive wire (80) at least partially contained within the cartridge heater (78), the heating element (14) is configured to be resistively and thermally excited, which in turn causes the heating element (14) to heat the cartridge heater (78), the auger (68), and the filament (18) through at least one of convection, conduction, and radiative heat transfer, in response to the heating element (14) receiving an electric current.

11. The nozzle assembly of claim 10 wherein the drive mechanism (22) is a nozzle (46) rotatably mounted to the printer head by a free bearing that permits the nozzle (46) to be quickly released and attached to the printer head.

12. The nozzle assembly of claim 11 wherein the nozzle (46) is a tubular sleeve (46), and the at least one drive surface (44) is an inner diameter surface (48) of the sleeve (46) that defines an elongated bore (50) in fluid communication between the feed opening (36) and the discharge opening (38), such that rotation of the sleeve (46) relative to the printer head causes the inner diameter surface (48) to transmit a rotational force to the filament (18) disposed within the bore (50).

13. The nozzle assembly of claim 12 wherein the drive mechanism (22) includes an annular flange (42) extending from the sleeve (46), where the annular flange (42) is a rotor (54) having at least one driven surface (40) configured to receive an input force from the motor (52) for moving the drive mechanism (22) relative to the printer head.

14. The nozzle assembly of claim 13 wherein the guide (60) cooperates with the drive mechanism (22) to displace the filament (18) from the feed opening (36) to the discharge opening (38), with the guide (60) disposed at least partially within the bore (50) of the drive mechanism (22) and including at least one guide surface (66) configured to deflect the filament (18) toward the discharge end (32) in response to the drive mechanism (22) moving relative to the guide (60).

15. The nozzle assembly of claim 14 wherein the guide (60) is an auger (68) including an elongated shaft (70) disposed at least partially within the bore (50) of the sleeve (46).

16. The nozzle assembly of claim 15 wherein the auger (68) includes a helical ramp (72) extending from the elongated shaft (70), with the helical ramp (72) having a bottom surface (74) defining the at least one guide surface (66), the helical ramp (72) having one of a left handedness and a right handedness, and the helical ramp (72) is configured to deflect the filament (18) toward the discharge end (32), in response to the sleeve (46) rotating about the longitudinal axis (34) for transmitting a rotational force to the filament (18) in a rotational direction associated with the handedness of the helical ramp (72).

17. A printer head for a 3D printer comprising:
a nozzle assembly comprising:
a guide (60) held in a fixed position relative to the printer head and extending from a first end (62) to a second end (64) along a longitudinal axis (34), the guide (60) comprising an auger (68) that defines a cavity (76);
a heating element (14) comprising a resistive wire (80) disposed within the cavity (76) of the auger (68) and held in a fixed position relative to the printer head;
a sensor (16) attached to the guide (60) such that the sensor (16) is held in a fixed position relative to the printer head, with the sensor (16) being configured to measure heat based on a resistance change in the resistive wire (80);
a drive mechanism (22) extending from a feed end (30) to a discharge end (32) along the longitudinal axis (34), the feed end (30) defining a feed opening (36) for receiving a filament (18) from the feed system (20), the discharge end (32) defining a discharge opening (38) for discharging the filament (18) from the nozzle assembly, and the drive mechanism (22) is movable relative to the printer head and the guide (60) and includes at least one drive surface (44) for engaging the filament (18) and causing the filament (18) to move from the feed opening (36) to the discharge opening (38), in response to the drive mechanism (22) moving relative to the printer head; and
a motor (52) for moving the drive mechanism (22) relative to the printer head; and
a feed system for feeding the filament (18) into the nozzle assembly.

18. The printer head of claim 17 wherein the nozzle (46) is a tubular sleeve (46), with the at least one drive surface (44) of the drive mechanism (22) being an inner diameter surface (48) of the sleeve (46) that defines an elongated bore (50) in fluid communication between the feed opening (36) and the discharge opening (38), such that rotation of the sleeve (46) relative to the printer head causes the inner diameter surface (48) to transmit a rotational force to the filament (18) disposed within the bore (50), and the bore (50) includes a taper at the discharge end (32) so as to enhance the heating properties of the heating element (14).

19. The printer head of claim 18 wherein the guide (60) is an auger (68) including an elongated shaft (70) disposed at least partially within the bore (50) of the sleeve (46).

20. The printer head of claim 19 wherein the auger (68) includes a helical ramp (72) extending from the elongated shaft (70), with the helical ramp (72) having a bottom surface (74) defining the at least one guide surface (66).
